(19) United States
(12) Patent Application Publication
(10) Pub. No.: US 2026/0336829 A1
(43) Pub. Date: Oct. 29, 2026

(54) SYSTEMS AND METHODS FOR VERIFYING A PERSON LOCATED AT A BAG DROP STATION

(71) Applicant: UNITED AIRLINES, INC., Chicago, IL (US)

(72) Inventors: Sagi Varghese, Downers Grove, IL (US); George Edwards, Orlando, FL (US)

(21) Appl. No.: 19/657,277

(22) Filed: Apr. 24, 2026

Related U.S. Application Data
(60) Provisional application No. 63/794,581, filed on Apr. 25, 2025.

(51) Int. Cl. B64F 1/36; G06F 21/32; G06K 7/10; G06V 40/16

(52) U.S. Cl. CPC B64F 1/368; G06F 21/32; G06K 7/10445; G06V 40/172

(57) ABSTRACT

A bag drop station may capture, via a scanning device, record information for a passenger from an identifier tag presented to the scanning device. The bag drop station may determine whether the passenger is eligible to use a primary biometric verification process associated with a traveler verification service. The bag drop station may, in response to determining that the passenger is eligible, use the primary biometric verification process. The primary biometric verification process may include activating one or more cameras to capture a biometric process image of a person located at the bag drop station, retrieving a verified image from a secured database associated with the traveler verification service, determining whether the person captured in the biometric process image is the passenger, and activating a bag management component to initiate a bag collection process in response to determining that the person captured in the biometric process image is the passenger.

### CROSS-REFERENCE TO RELATED APPLICATIONS

This application is a non-provisional patent application which claims the benefit of U.S. provisional application No. 63/794,581, filed Apr. 25, 2025, the entire contents of which is fully incorporated herein by reference.

### TECHNICAL FIELD

The present disclosure generally relates to autonomous or semi-autonomous bag drop stations located at an airport, and, more particularly, to systems and methods for verifying the identity of a person located at a bag drop station.

### BACKGROUND

Aircraft passengers that wish to check a bag for any portion of their trip are required to verify their identities before the bag is either manually or automatically transferred for loading onto a departing aircraft. Traditionally, the verification process is performed manually by dedicated personnel at a check-in counter or similar. However, this process is time consuming and frustrating to passengers. Furthermore, existing autonomous or semi-autonomous solutions to verify a passenger's identity and collect a bag are configured to use only a single type of biometric verification process linked to hardware and software constraints of current automated bag drop systems.

As such, there is a need for improved systems and methods to verify a passenger identity. In particular, improvements in selecting from different possible biometric verification methods and fallback manual verification methods as a function of bag drop hardware, airport capabilities, and/or passenger consent and service enrolment are needed.

### SUMMARY

In some aspects, the techniques described herein relate to a bag drop station computer system including: a scanning device; one or more cameras; a bag management component; one or more processors electrically coupled to the bag management component, the scanning device, and the one or more cameras; and one or more non-transitory, computer-readable media storing instructions that, when executed by the one or more processors, cause the bag drop station to: capture, via the scanning device, record information for a passenger from an identifier tag presented to the scanning device in connection with collection of a bag by the bag drop station; determine whether the passenger is eligible to use a primary biometric verification process associated with a traveler verification service based on the record information; and in response to determining that the passenger is eligible to use the primary biometric verification process: activate the one or more cameras to capture a biometric process image of a person located at the bag drop station; retrieve a verified image of the passenger from a secured database associated with the traveler verification service; determine, based on the verified image, whether the person captured in the biometric process image is the passenger; and activate the bag management component to initiate a bag collection process for the bag in response to determining that the person captured in the biometric process image is the passenger.

In some aspects, the techniques described herein relate to a computer implemented method for verifying a person located at a bag drop station, the method including: capturing, via a scanning device of the bag drop station, record information for a passenger from an identifier tag presented to the scanning device in connection with collection of a bag by the bag drop station; determining, by one or more processors, whether the passenger is eligible to use a primary biometric verification process associated with a traveler verification service based on the record information; and in response to determining that the passenger is eligible to use the primary biometric verification process: activating, by the one or more processors, one or more cameras of the bag drop station to capture a biometric process image of a person located at the bag drop station; retrieving, by the one or more processors, a verified image of the passenger from a secured database associated with a traveler verification service; determining, by the one or more processors and based on the verified image, whether the person captured in the biometric process image is the passenger; and activating, by the one or more processors, a bag management component of the bag drop station to initiate a bag collection process for the bag in response to determining that the person captured in the biometric process image is the passenger.

In some aspects, the techniques described herein relate to a tangible, non-transitory computer-readable medium storing instructions, that, when executed by one or more processors of a bag drop station, cause the bag drop station to: capture, via a scanning device of the bag drop station, record information for a passenger from an identifier tag presented to the scanning device in connection with collection of a bag by the bag drop station; determine, by one or more processors, whether the passenger is eligible to use a primary biometric verification process associated with a traveler verification service based on the record information; and in response to determining that the passenger is eligible to use the primary biometric verification process: activate one or more cameras of the bag drop station to capture a biometric process image of a person located at the bag drop station; retrieve a verified image of the passenger from a secured database associated with a traveler verification service; determine, based on the verified image, whether the person captured in the biometric process image is the passenger; and activate a bag management component of the bag drop station to initiate a bag collection process for the bag in response to determining that the person captured in the biometric process image is the passenger.

### BRIEF DESCRIPTION OF THE DRAWINGS

The Figures described below depict various aspects of the system and methods disclosed therein. It should be understood that each Figure depicts an embodiment of a particular aspect of the disclosed system and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and instrumentalities shown, wherein:

FIG. 1 illustrates a block diagram of an example system for verifying a person located at a bag drop station, in accordance with various embodiments disclosed herein.

FIG. 2 is a flow diagram of an example method for determining a verification process to use to verify a person located at the bag drop station of FIG. 1, in accordance with various embodiments disclosed herein.

FIG. 3 is a flow diagram of an example biometric verification process using the system of FIG. 1, in accordance with various embodiments disclosed herein.

FIG. 4 is a flow diagram of another example biometric verification process using the system of FIG. 1, in accordance with various embodiments disclosed herein.

FIG. 5 is a flow diagram of an example computer implemented method for verifying a person located at a bag drop station, in accordance with various embodiments disclosed herein.

The Figures depict preferred embodiments for purposes of illustration only. Alternative embodiments of the systems and methods illustrated herein may be employed without departing from the principles of the invention described herein.

### DETAILED DESCRIPTION

The disclosed system and methods represent a technological advancement in automated passenger identity verification as compared to traditional bag check-in and identity verification processes. In particular, the disclosed bag drop station leverages a dynamic and multi-modal biometric verification approach that accelerates passenger throughput and enhances overall security. The system intelligently selects from a range of biometric and fallback verification processes such as a primary biometric verification linked to a secure remote database, an alternative one-to-one biometric process, and/or a manual verification process based on passenger enrollment status, available airport hardware, and operational conditions. This modular approach provides increased flexibility, enabling the system to adapt to varied airport capabilities and shifting security requirements while reducing passenger wait times and alleviating potential processing bottlenecks.

Furthermore, the integration of diverse sensing technologies and communications interfaces such as high-resolution cameras and advanced scanning devices ensure robust capture and analysis of both physical identifiers (e.g., boarding passes, printed bag tags) and biometric indicators of a person located at a bag drop station. These improvements allow the system to verify a passenger's identity through multiple corroborative steps. In cases where a primary verification process may not be feasible, the system can seamlessly transition to alternate verification methods, including one-to-one biometric matching or manual oversight via attendant notifications. This layered verification strategy, combined with near real-time retrieval of passenger data from secured databases enhances security measures and delivers a more streamlined and user-friendly experience.

Overall, the architecture of the disclosed systems and methods offers enhancements in scalability, interoperability, and operational efficiency. By modularly combining hardware components with adaptive software-based decision making, the system can be updated or augmented, through software or firmware updates, to meet evolving regulatory guidelines and customer service expectations. These technology-related improvements are particularly significant in high-traffic environments, where dynamic adaptability and seamless integration of biometric, document-based, and manual verification processes can substantially improve passenger throughput, security, and overall satisfaction.

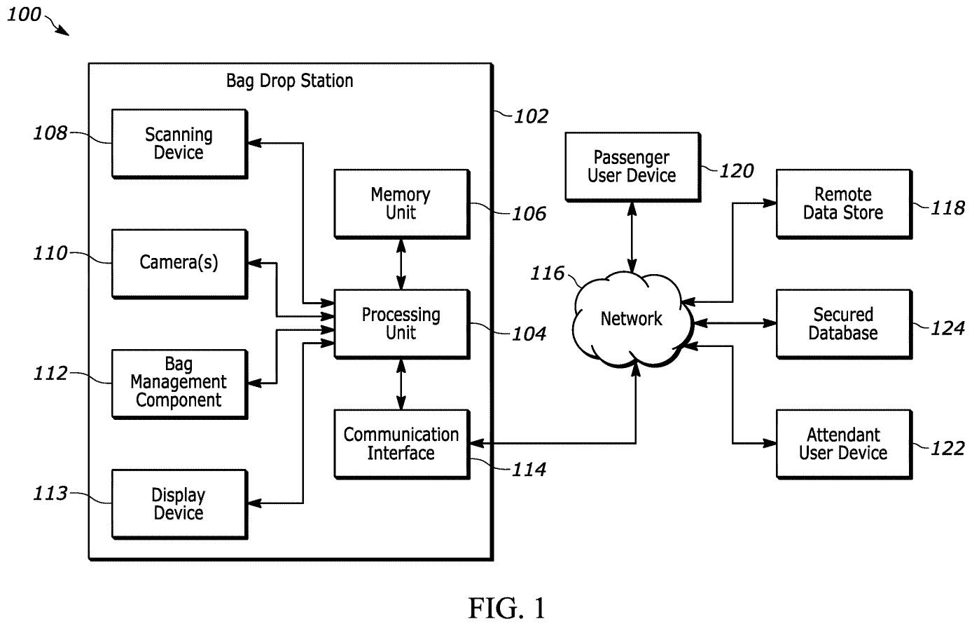

FIG. 1 illustrates a block diagram of an example system 100 for verifying a person located at a bag drop station. The system 100 includes a bag drop station 102 that may be deployed in or proximate to an airport terminal to facilitate an automated or semi-automated process of verifying a personal and securely surrendering a checked bag for transport to and aircraft. The bag drop station 102 may include a processing unit 104, a memory unit 106, a scanning device 108, one or more cameras 110, a bag management component 112, a display device 113 (e.g., an LED, OLED, LCD, or similar display technology known in the art), and a communication interface 114.

Processing unit 104 includes one or more processors, each of which may be a programmable microprocessor or the like that executes software or other computing instructions stored in memory unit 106 to execute some or all of the functions of the system 100 as described herein. Processing unit 104 may include one or more graphics processing units (GPUs) and/or one or more central processing units (CPUs), for example. Alternatively, or in addition, one or more processors in processing unit 104 may be other types of processors (e.g., application-specific integrated circuits (ASICs), field-programmable gate arrays (FPGAs), etc.), and some of the functionality of the system 100 as described herein may instead be implemented in hardware.

Memory unit 106 may include one or more volatile and/or non-volatile memories. Any suitable memory type or types may be included in memory unit 106, such as read-only memory (ROM) and/or random access memory (RAM), flash memory, a solid-state drive (SSD), a hard disk drive (HDD), and so on. Collectively, memory unit 106 may store one or more software applications, the data received/used by those applications, and the data output/generated by those applications. In particular, the memory unit 106 may store instructions for specific modules or components of the bag drop station 102 as described herein. In particular, the memory unit 106 stores the software and instructions that, when executed by processing unit 104, perform various functions of the bag drop station 102 related to verifying the identity of a person located at the bag drop station 102 as described herein. Such functions may include controlling and directing operation of the scanning device 108, the one or more cameras 110, the bag management component 112, the display device 113, and the communication interface 114. Furthermore, the software and instructions may be packaged as a software or firmware update to existing bag drop stations. In these embodiments, the verification functions used by the bag drop station 102 may be dependent on the features of the bag drop station 102 and/or the airport in which the bag drop station 102 is deployed.

The scanning device 108 may be electrically coupled to the processing unit 104 and generally includes a device configured to capture, receive, decode, etc. record information for a passenger from an identifier tag presented to the scanning device 108 in connection with collection of a bag by the bag drop station 102. For example, the scanning device 108 may include at least one of a camera, a bar code scanner, a radio frequency ID reader, a near field communication device, etc. Furthermore, the identifier tag presented to the scanning device 108 may include a printed bag tag for the bag and/or a boarding pass for the passenger. In some embodiments, the identifier tag may be printed by another autonomous station located at the airport in response to verification of the passenger's photo identification document. Additionally or alternatively, the identifier tag may include a barcode, an RFID tag, an NFC tag, or other similar computer readable indicia. In some embodiments, the identifier tag may be located in the passenger's baggage and used in conjunction with another identifier tag (e.g. the passenger's boarding pass or bag tag) to verify the record information is a match for both tags before proceeding to one or more of the biometric verification processes described herein.

The record information retrieved by the scanning device 108 from the identifier tag may include information that the bag drop station 102 uses to verify the identity of the person located at the bag drop station 102. For example, in some embodiments, the record information includes an indication that the passenger is enrolled in a traveler verification service and that the passenger has affirmatively opted in to a primary biometric verification process used by the bag drop station 102. However, in some embodiments, the bag drop station 102 may use the record information to retrieve account information for the passenger from a remote data store 118 via the communication interface 114 and a network 116 shown in FIG. 1. The account information may indicate enrollment in the traveler verification service and/or confirm that the user opted in to the primary biometric verification process.

In some embodiments, the passenger may opt-in to the primary biometric verification process using a passenger user device 120 (e.g., a personal computer, phone, tablet, etc.). For example, a remote computing system associated with the remote data store 118 may prompt the user via the passenger user device 120 to opt-in to the primary biometric verification process when booking a flight and/or when setting up an account using the remote computing system. Additionally, or alternatively, the bag drop station 102 may prompt the person located at the bag drop station 102 (e.g., via the display device 113) to opt-in to the primary biometric verification process. For example, the bag drop station 102 may solicit the person to opt-in to the primary biometric verification process when the record information and/or the account information indicates that the passenger is enrolled in the traveler verification service but has not affirmatively opted-in to using the primary biometric verification process.

In some embodiments, the passenger user device 120 may include a digital wallet application configured to store digital identification credentials for the passenger. The digital identification credentials may include one or more of a digital driver's license, a digital state identification card, a digital passport, or other digital credentials issued by a government authority or other trusted entity. The digital identification credentials may include a digital image of the passenger that depicts the passenger's face or other biometric features. The bag drop station 102 may be configured to receive the digital identification credentials from the digital wallet via the scanning device 108 (e.g., via near field communication) or via the communication interface 114. In some embodiments, the bag drop station 102 may present instructions on the display device 113 that direct the person located at the bag drop station 102 to present the passenger user device 120 to the scanning device 108 to transfer the digital identification credentials. In these embodiments, the bag drop station 102 may use the digital image included in the digital identification credentials to verify the identity of the person located at the bag drop station 102 as part of the primary biometric verification process, the alternative biometric verification process, or the one-to-one biometric verification process described herein.

The one or more cameras 110 may be electrically coupled to the processing unit 104 and generally include imaging devices known in the art that are configured to capture images of a person located at the bag drop station 102 when directed by the processing unit 104 and to return the captured images to the processing unit 104 for further processing and analysis. In some embodiments, at least one of the one or more cameras 110 may be located remote from the bag drop station 102. In these embodiments, the remote camera may communicate with the processing unit 104 via the communication interface 114 and the network 116 shown in FIG. 1.

The bag management component 112 may include one or more hardware and/or software components of the bag drop station 102 configured to facilitate movement of bag from the bag drop station 102 to a secured location for eventual transportation onto an aircraft assigned to a flight associated with the passenger. For example, in some embodiments, the bag management component 112 includes a computer-controlled bag conveyor system associated with the bag drop station 102. The bag drop station 102 may activate the computer-controlled bag conveyor system to transport the bag to a secured location. Additionally or alternatively, in some embodiments, the bag management component 112 may include an attendant notification component of the bag drop station 102 that the bag drop station 102 activates to signal an attendant associated with the bag drop station to collect the bag from the bag drop station 102 after the person has been verified as described herein. The attendant notification component may include one or more of a visual indicator of the bag drop station 102, an audio indicator of the bag drop station 102 that is configured to broadcast an audio notification directing the attendant to collect the bag from the bag drop station 102, etc. Furthermore, in some embodiments, the attendant notification component may include an electronic transmitter or network interface such as the communication interface 114 that transmits an electronic notification to an attendant user device 122 associated with the attendant for the 102. The attendant user device 122 may include a phone, tablet, computer, etc. that signals the attendant to collect the bag from the bag drop station 102.

Communication interface 114 includes one or more hardware and/or software components that are generally configured to enable the bag drop station 102 to communicate, via the network 116, with other components and/or devices of the system 100, such as the remote data store 118, the passenger user device 120, the attendant user device 122, and a secured database 124 associated with the traveler verification service. To this end, the communication interface 114 includes hardware and/or software that operates in accordance with at least one communication protocol of the network 116.

The network 116 includes one or more wired and/or wireless communication networks, such as a cellular network (e.g., 5G®, 4G LTE®, 3G®), a Wi-Fi® network (i.e., an IEEE 802.11 standards network), a microwave access network (e.g., WiMAX®), and/or any other suitable wide area network (WAN), local area network (LAN), personal area network (PAN), etc. As just one example, the network 116 may include both a wireless LAN such as a Wi-Fi® network and a WAN such as the Internet.

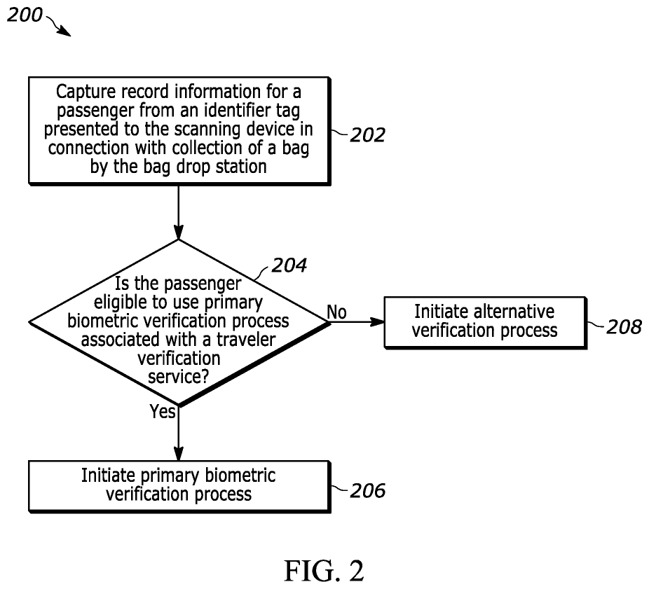

Operation of the system 100 and the bag drop station 102 to verify the identity of a person located at the bag drop station 102 will be discussed in more detail with reference to the methods 200, 300, and 400 shown in FIGS. 2, 3, and 4, respectively.

FIG. 2 is a flow diagram of an example method 200 for determining a verification process to use to verify the person located at the bag drop station 102. In particular, the method 200 includes the bag drop station 102 determining whether to apply a primary biometric verification process used by the bag drop station 102 or an alternative verification process. In general, the primary biometric verification process is a function of the capabilities of bag drop station 102 and/or the airport in which the bag drop station 102 is deployed. The method 200 may be performed by the processing unit 104 executing instructions stored on the memory unit 106.

The primary biometric verification process may include a biometric process that is associated with the traveler verification service that the passenger may be enrolled with such as TSA Touchless ID or other similar approved touchless verification service. However, in some embodiments, the bag drop station 102 and/or the airport in which the bag drop station 102 is deployed may not be setup to use the traveler verification service (e.g., the bag drop station 102 may not have approved equipment or access credentials to interface with the traveler verification service). In these embodiments, the primary verification service may include a one-to-one biometric verification service.

The alternative verification process may include an alternative biometric verification process and/or a manual verification process. For example, where the bag drop station 102 is configured to use the biometric process that is associated with the traveler verification service and the one-to-one biometric verification service, the alternative verification process may include the one-to-one biometric verification service followed by the manual verification process. However, where the bag drop station 102 is configured to use the biometric process that is associated with the traveler verification service and not the one-to-one biometric verification service (e.g., because the bag drop station 102 does not include cameras or scanning equipment to capture both an image of photo identification document and the person located at the bag drop station 102), the alternative verification process may include the manual verification process. It should be appreciated that different combinations and priorities of these verification process are also possible.

At operation 202, the method 200 includes the bag drop station 102 capturing the record information for the passenger from the identifier tag presented to the scanning device 108. In particular, the processing unit 104 may direct the scanning device 108 to scan the identifier tag and/or receive the record information as a data push from the scanning device 108 in response to the identifier tag being presented.

At operation 204, the method 200 includes the bag drop station 102 determining whether the passenger is eligible to use the primary biometric verification process based on the record information. For example, where the primary biometric verification process includes the biometric process that is associated with the traveler verification service, the method 200 may include the bag drop station 102 using the record information or the account information retrieved using the record information to determine whether the passenger is both enrolled in the traveler verification service and has opted-in to use of the service.

At operation 206, the method 200 may include the bag drop station 102 initiating the primary biometric verification process when the result of operation 204 indicates that the passenger is eligible (e.g., the passenger is both enrolled in the traveler verification service and has opted-in to use of the service).

At operation 208, the method 200 may include the bag drop station 102 initiating the alternative biometric verification process when the result of operation 204 indicates that the passenger is not eligible (e.g., the passenger is not enrolled in the traveler verification service or has not opted-in to use of the service).

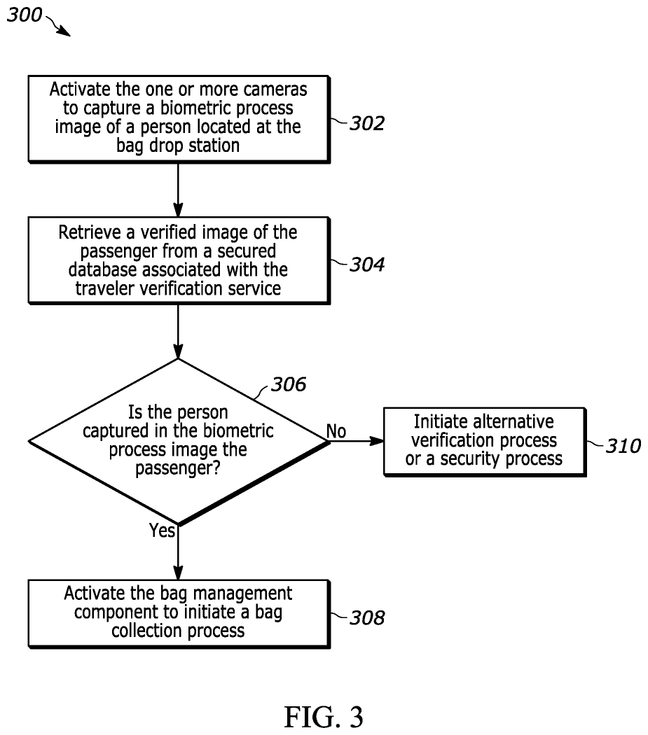

FIG. 3 is a flow diagram of a method 300 for performing the biometric verification process that is associated with the traveler verification service. The method 300 may be performed by the processing unit 104 executing instructions stored on the memory unit 106.

At operation 302, the method 300 may include the bag drop station 102 activating the one or more cameras 110 to capture a biometric process image of the person located at the bag drop station 102.

At operation 304, the method 300 may include the bag drop station 102 retrieving a verified image of the passenger from the secured database 124. For example, the bag drop station 102 may transmit passenger information (e.g., a name and other identifying details of the passenger) to a computing system associated with the secured database 124 which if possible retrieves the verified image from the secured database 124 for transmission back to the bag drop station 102. The passenger information may be included directly in the record information or in the account information retrieved from the remote data store 118 using the record information.

At operation 306, the method 300 may include the bag drop station 102 determining, based on the verified image, whether the person captured in the biometric process image is the passenger. For example, the bag drop station 102 may perform face matching or other similar processes known in the art between the verified image and the biometric process image to determine whether the same individual (e.g., the passenger) is depicted in each image.

In some embodiments, the method 300 may use the remote computing system associated with the secured database 124 to determine whether the person captured in the biometric process image is the passenger. In these embodiments, the method 300 may include the bag drop station 102 transmitting the biometric process image to the remote computing system and receiving back an indication that the person depicted in the biometric process image matches the verified image of the passenger contained in the secured database 124.

In some embodiments, the secured database 124 may be linked to the departure airport. In these embodiments, the verified image of the passenger may be placed in the secured database 124 prior to the departure time of a planned flight from the departure airport that is associated with the passenger (e.g., when the passenger books the flight, when the passenger checks into the flight, or at some other preconfigured time). Furthermore, in these embodiments, the bag drop station 102 and/or the computing system associated with the secured database 124 may compare the biometric process image to all of the images contained in the secured database 124 to identify a match without needing to first identify the verified image associated with the passenger.

At operation 308, the method 300 may include the bag drop station 102 activating the bag management component 112 to initiate the bag collection process for the bag in response to determining that the person captured in the biometric process image is the passenger. In some embodiments, the method 300 may also include the bag drop station 102 printing a bag tag for the bag associated with the passenger in response to determining that the person captured in the biometric process image is the passenger and then activating the bag management component 112 to initiate the bag collection process.

At operation 310, the method 300 may include the bag drop station 102 initiating the alternative verification process (e.g., the one-to-one biometric verification process or the manual verification process) or a security process in response to determining that the person captured in the biometric process image is not the passenger. The security process may include sounding an alarm, signaling the attendant, and/or signaling security personnel located in the airport that an individual who is not the passenger is attempting to surrender the bag. In some embodiments, the bag drop station 102 may attempt to retry operations 302, 304, and 306, a preconfigured number of times (e.g., one or two additional times) before performing operation 310.

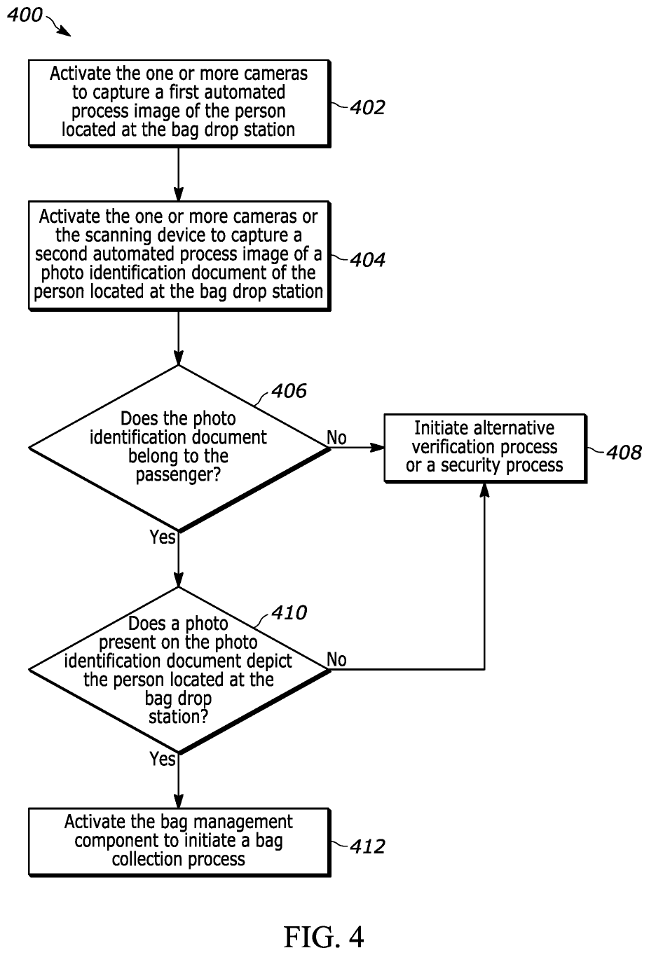

FIG. 4 is a flow diagram of a method 400 for performing the one-to-one biometric verification process either as the primary or alternative biometric verification process for the bag drop station 102. The method 400 may be performed by the processing unit 104 executing instructions stored on the memory unit 106.

At operation 402, the method 400 may include the bag drop station 102 activating the one or more cameras 110 to capture a first automated process image of the person located at the bag drop station.

At operation 404, the method 400 may include the bag drop station 102 activating the one or more cameras 110 or the scanning device 108 to capture a second automated process image of a photo identification document presented by the person located at the bag drop station. In some embodiments, the bag drop station 102 may present instructions on the display device 113 that direct the person at the bag drop station 102 to present the photo identification document to the one or more cameras or the scanning device. In some embodiments, the operations 402 and 404 may be performed at approximately the same time to ensure that the first automated process image is an image of the person at the bag drop station 102 and not an image of the photo identification document.

In some embodiments, the photo identification document may include digital identification credentials and digital image of the passenger stored in the digital wallet on the passenger user device 120. In these embodiments, the bag drop station 102 may receive the digital identification credentials, including the digital image, from the digital wallet via the scanning device 108 (e.g., via near field communication) or via the communication interface 114. The bag drop station 102 may use the digital image included in the digital identification credentials in place of or in addition to the second automated process image to perform the one-to-one biometric verification process. For example, at operation 410, the bag drop station 102 may compare the first automated process image of the person located at the bag drop station 102 to the digital image included in the digital identification credentials to determine whether the photo present in the digital identification credentials depicts the person located at the bag drop station 102.

At operation 406, the method 400 may include the bag drop station 102 determining whether the photo identification document belongs to the passenger. For example, the bag drop station 102 may compare identifying details on the photo identification document such as a name, birthdate, address, image, etc. to features of the passenger noted in the record or account information (e.g., the name, birthdate, address, image, physical description etc. of the passenger).

At operation 408, the method 400 may include the bag drop station 102 initiating the alternative verification process or the security process in response to determining that the photo identification document does not belong to the passenger.

At operation 410, the method 400 may include the bag drop station 102 determining, based on the second automated process image, whether a photo present on the photo identification document depicts the person located at the bag drop station 102 as captured in the first automated process image. As shown in FIG. 4, the bag drop station 102 may perform operation 410 in response to determining that the photo identification document belongs to the passenger. However, in some embodiments, the bag drop station 102 may perform operation 410 before or in parallel with operation 406. In response to determining that the photo identification document does not depict the person located at the bag drop station 102, the method 400 may include performing the operation 408.

At operation 412, the method 400 may include the bag drop station 102 activating the bag management component 112 to initiate the bag collection process for the bag in response to determining that the photo identification document does depict the person located at the bag drop station 102. In some embodiments, the method 400 may also include the bag drop station 102 printing a bag tag for the bag associated with the passenger in response to the photo identification document does depict the person located at the bag drop station 102 and then activating the bag management component 112 to initiate the bag collection process.

As described above, the bag drop station 102 may initiate a manual identification process as the final fallback verification process to the biometric verification process associated with the traveler verification service and/or the one-to-one biometric verification process. To initiate the manual verification process, the bag drop station 102 may present instructions on the display device 113 that direct the person located at the bag drop station 102 to present the photo identification document to the attendant associated with the bag drop station 102. Furthermore, the manual verification process may include transmitting a notification to the attendant user device 122 or activate an indicator of the bag drop station to signal that manual photo identification by the attendant is needed.

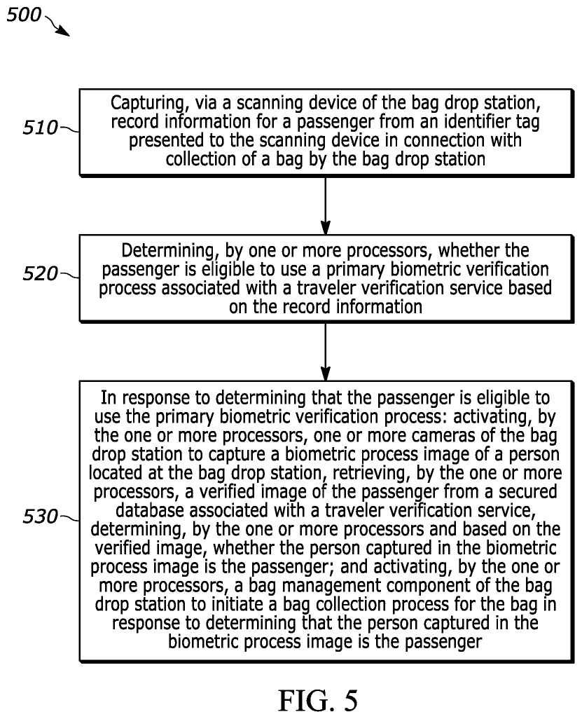

FIG. 5 shows a method 500 for verifying a person located at a bag drop station (e.g., bag drop station 102). The method 500 may be performed by the processing unit 104 executing instructions stored on the memory unit 106.

At operation 510, the method 500 may include capturing, via a scanning device (e.g., the scanning device 108) of the bag drop station, record information for a passenger from an identifier tag presented to the scanning device in connection with collection of a bag by the bag drop station. The scanning device may include at least one of an additional camera, a bar code scanner, a radio frequency ID reader, or a near field communication device. The identifier tag may include a printed bag tag for the bag and/or a boarding pass for the passenger.

At operation 520, the method 500 may include determining, by one or more processors, whether the passenger is eligible to use a primary biometric verification process associated with a traveler verification service based on the record information.

At operation 530, the method 500 may include in response to determining that the passenger is eligible to use the primary biometric verification process: activating, by the one or more processors, one or more cameras (e.g., one or more cameras 110) of the bag drop station to capture a biometric process image of a person located at the bag drop station, retrieving, by the one or more processors, a verified image of the passenger from a secured database (e.g., secured database 124) associated with a traveler verification service, determining, by the one or more processors and based on the verified image, whether the person captured in the biometric process image is the passenger; and activating, by the one or more processors, a bag management component (e.g., bag management component 112) of the bag drop station to initiate a bag collection process for the bag in response to determining that the person captured in the biometric process image is the passenger.

In some embodiments, determining whether the passenger is eligible to use the primary biometric verification process may include obtaining account information for the passenger from a remote data store (e.g., remote data store 118) based on the record information and determining that the passenger is eligible to use the primary biometric verification process in response to determining that the account information indicates enrollment in the traveler verification service and user input opting in to the primary biometric verification process.

In some embodiments, determining whether the passenger is eligible to use the primary biometric verification process may include determining that the passenger is eligible to use the primary biometric verification process in response to determining that the record information indicates enrollment in traveler verification service and user input opting in to the primary biometric verification process.

In some embodiments, the method 500 may also include, in response to determining that the passenger is not eligible to use the primary biometric verification process, initiating an alternative biometric verification process for the person located at the bag drop station by: activating, by the one or more processors, the one or more cameras to capture a first automated process image of the person located at the bag drop station; activating, by the one or more processors, the one or more cameras or the scanning device to capture a second automated process image of a photo identification document of the person located at the bag drop station; determining, by the one or more processors, whether the photo identification document belongs to the passenger; determining, by the one or more processors and based on the second automated process image, whether a photo present on the photo identification document depicts the person located at the bag drop station as captured in the first automated process image; and in response to determining that the photo present on the photo identification document depicts the person located at the bag drop station and the photo identification document belongs to the passenger, activating, by the one or more processors, the bag management component to initiate the bag collection process for the bag.

In some embodiments, the method 500 includes in response to determining that the photo present on the photo identification document fails to depict the person located at the bag drop station or the photo identification document fails to belong to the passenger, initiating a manual identification process.

In some embodiments, the method 500 includes presenting, on a display device (e.g., display device 113), instructions that direct the person located at the bag drop station to present the photo identification document to the one or more cameras or the scanning device.

In some embodiments, the method 500 includes, in response to determining that the passenger is not eligible to use the primary biometric verification process, initiating an alternative manual verification process for the person located at the bag drop station by: transmitting, by the one or more processors, a notification to an attendant device (e.g., attendant user device 122) assigned to the bag drop station or activate an indicator of the bag drop station to signal that that manual photo identification verification needed.

In some embodiments, the bag management component includes a computer-controlled bag conveyor system associated with the bag drop station. In these embodiments, the method 500 includes activating the bag management component to initiate the bag collection process by activating the computer-controlled bag conveyor system to transport the bag to a secured location.

In some embodiments, the bag management component includes an attendant notification component of the bag drop station, and the method 500 includes initiating the bag collection process by activating the attendant notification component to signal an attendant associated with the bag drop station to collect the bag from the bag drop station. The attendant notification component may include one or more of a visual indicator of the bag drop station, an audio indicator of the bag drop station configured to broadcast an audio notification directing the attendant to collect the bag from the bag drop station, or an electronic transmitter configured to transmit an electronic notification to a user device associated with the attendant.

### Additional Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The systems and methods described herein are directed to an improvement to computer functionality, and improve the functioning of conventional computers. Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules include a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also may include the plural unless it is obvious that it is meant otherwise.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 812(f) unless traditional means-plus-function language is expressly recited, such as “means for” or “step for” language being explicitly recited in the claim(s).

What is claimed is:

1. A bag drop station computer system comprising:
a scanning device;
one or more cameras;
a bag management component;
one or more processors electrically coupled to the bag management component, the scanning device, and the one or more cameras; and
one or more non-transitory, computer-readable media storing instructions that, when executed by the one or more processors, cause the bag drop station to:
capture, via the scanning device, record information for a passenger from an identifier tag presented to the scanning device in connection with collection of a bag by the bag drop station;
determine whether the passenger is eligible to use a primary biometric verification process associated with a traveler verification service based on the record information; and
in response to determining that the passenger is eligible to use the primary biometric verification process:
activate the one or more cameras to capture a biometric process image of a person located at the bag drop station;
retrieve a verified image of the passenger from a secured database associated with the traveler verification service;
determine, based on the verified image, whether the person captured in the biometric process image is the passenger; and
activate the bag management component to initiate a bag collection process for the bag in response to determining that the person captured in the biometric process image is the passenger.

2. The bag drop station computer system of claim 1 wherein in response to determining that the passenger is not eligible to use the primary biometric verification process, the instructions, when executed by the one or more processors, cause the bag drop station to initiate an alternative biometric verification process for the person located at the bag drop station by:
activating the one or more cameras to capture a first automated process image of the person located at the bag drop station;
activating the one or more cameras or the scanning device to capture a second automated process image of a photo identification document of the person located at the bag drop station;
determining whether the photo identification document belongs to the passenger;
determining, based on the second automated process image, whether a photo present on the photo identification document depicts the person located at the bag drop station as captured in the first automated process image; and
in response to determining that the photo present on the photo identification document depicts the person located at the bag drop station and the photo identification document belongs to the passenger, activating the bag management component to initiate the bag collection process for the bag.

3. The bag drop station computer system of claim 2 wherein in response to determining that the photo present on the photo identification document fails to depict the person located at the bag drop station or the photo identification document fails to belong to the passenger, the instructions, when executed by the one or more processors, cause the bag drop station to initiate a manual identification process.

4. The bag drop station computer system of claim 2 further comprising a display device electrically coupled to the one or more processors and wherein, the instructions, when executed by the one or more processors, cause the bag drop station to initiate the alternative biometric verification process by:
presenting instructions on the display device that direct the person located at the bag drop station to present the photo identification document to the one or more cameras or the scanning device.

5. The bag drop station computer system of claim 1 wherein in response to determining that the passenger is not eligible to use the primary biometric verification process, the instructions, when executed by the one or more processors, cause the bag drop station to initiate an alternative manual verification process for the person located at the bag drop station by:
transmitting a notification to an attendant device assigned to the bag drop station or activate an indicator of the bag drop station to signal that that manual photo identification verification needed.

6. The bag drop station computer system of claim 1 wherein the bag management component includes a computer-controlled bag conveyor system associated with the bag drop station, and wherein to activate the bag management component and initiate the bag collection process, the instructions, when executed by the one or more processors, cause the bag drop station to:
activate the computer-controlled bag conveyor system to transport the bag to a secured location.

7. The bag drop station computer system of claim 1 wherein the bag management component includes an attendant notification component of the bag drop station, and wherein to activate the bag management component and initiate the bag collection process, the instructions, when executed by the one or more processors, cause the bag drop station to:
activate the attendant notification component to signal an attendant associated with the bag drop station to collect the bag from the bag drop station.

8. The bag drop station computer system of claim 7 wherein the attendant notification component includes one or more of a visual indicator of the bag drop station, an audio indicator of the bag drop station configured to broadcast an audio notification directing the attendant to collect the bag from the bag drop station, or an electronic transmitter configured to transmit an electronic notification to a user device associated with the attendant.

9. The bag drop station computer system of claim 1 wherein the scanning device includes at least one of an additional camera, a bar code scanner, a radio frequency ID reader, or a near field communication device.

10. The bag drop station computer system of claim 1 wherein the identifier tag includes a printed bag tag for the bag and/or a boarding pass for the passenger.

11. The bag drop station computer system of claim 1 wherein to determine whether the passenger is eligible to use the primary biometric verification process, the instructions, when executed by the one or more processors, cause the bag drop station to:
obtain account information for the passenger from a remote data store based on the record information; and
determine that the passenger is eligible to use the primary biometric verification process in response to determining that the account information indicates enrollment in the traveler verification service and user input opting in to the primary biometric verification process.

12. The bag drop station computer system of claim 1 wherein to determine whether the passenger is eligible to use the primary biometric verification process, the instructions, when executed by the one or more processors, cause the bag drop station to:
determine that the passenger is eligible to use the primary biometric verification process in response to determining that the record information indicates enrollment in traveler verification service and user input opting in to the primary biometric verification process.

13. A computer implemented method for verifying a person located at a bag drop station, the method comprising:
capturing, via a scanning device of the bag drop station, record information for a passenger from an identifier tag presented to the scanning device in connection with collection of a bag by the bag drop station;
determining, by one or more processors, whether the passenger is eligible to use a primary biometric verification process associated with a traveler verification service based on the record information; and
in response to determining that the passenger is eligible to use the primary biometric verification process:
activating, by the one or more processors, one or more cameras of the bag drop station to capture a biometric process image of a person located at the bag drop station;
retrieving, by the one or more processors, a verified image of the passenger from a secured database associated with a traveler verification service;
determining, by the one or more processors and based on the verified image, whether the person captured in the biometric process image is the passenger; and
activating, by the one or more processors, a bag management component of the bag drop station to initiate a bag collection process for the bag in response to determining that the person captured in the biometric process image is the passenger.

14. The method of claim 13 further comprising, in response to determining that the passenger is not eligible to use the primary biometric verification process, initiating an alternative biometric verification process for the person located at the bag drop station by:
activating, by the one or more processors, the one or more cameras to capture a first automated process image of the person located at the bag drop station;
activating, by the one or more processors, the one or more cameras or the scanning device to capture a second automated process image of a photo identification document of the person located at the bag drop station;
determining, by the one or more processors, whether the photo identification document belongs to the passenger;
determining, by the one or more processors and based on the second automated process image, whether a photo present on the photo identification document depicts the person located at the bag drop station as captured in the first automated process image; and
in response to determining that the photo present on the photo identification document depicts the person located at the bag drop station and the photo identification document belongs to the passenger, activating, by the one or more processors, the bag management component to initiate the bag collection process for the bag.

15. The method of claim 14 further comprising:
presenting, on a display device, instructions that direct the person located at the bag drop station to present the photo identification document to the one or more cameras or the scanning device.

16. The method of claim 13 further comprising, in response to determining that the passenger is not eligible to use the primary biometric verification process, initiating an alternative manual verification process for the person located at the bag drop station by:
transmitting, by the one or more processors, a notification to an attendant device assigned to the bag drop station or activate an indicator of the bag drop station to signal that that manual photo identification verification needed.

17. The method of claim 13 wherein the bag management component includes a computer-controlled bag conveyor system associated with the bag drop station, and wherein activating the bag management component to initiate the bag collection process includes:
activating, by the one or more processors, the computer-controlled bag conveyor system to transport the bag to a secured location.

18. The method of claim 13 wherein the bag management component includes an attendant notification component of the bag drop station, and initiating the bag collection process includes:
activating, by the one or more processors, the attendant notification component to signal an attendant associated with the bag drop station to collect the bag from the bag drop station.

19. A tangible, non-transitory computer-readable medium storing instructions, that, when executed by one or more processors of a bag drop station, cause the bag drop station to:
capture, via a scanning device of the bag drop station, record information for a passenger from an identifier tag presented to the scanning device in connection with collection of a bag by the bag drop station;
determine, by one or more processors, whether the passenger is eligible to use a primary biometric verification process associated with a traveler verification service based on the record information; and
in response to determining that the passenger is eligible to use the primary biometric verification process:
activate one or more cameras of the bag drop station to capture a biometric process image of a person located at the bag drop station;
retrieve a verified image of the passenger from a secured database associated with a traveler verification service;
determine, based on the verified image, whether the person captured in the biometric process image is the passenger; and
activate a bag management component of the bag drop station to initiate a bag collection process for the bag in response to determining that the person captured in the biometric process image is the passenger.

20. The tangible, non-transitory computer-readable medium of claim 19, wherein the instructions further cause the bag drop station to, in response to determining that the passenger is not eligible to use the primary biometric verification process, initiate an alternative biometric verification process for the person located at the bag drop station by:
activating the one or more cameras to capture a first automated process image of the person located at the bag drop station;
activating the one or more cameras or the scanning device to capture a second automated process image of a photo identification document of the person located at the bag drop station;
determining whether the photo identification document belongs to the passenger;
determining, and based on the second automated process image, whether a photo present on the photo identification document depicts the person located at the bag drop station as captured in the first automated process image; and
in response to determining that the photo present on the photo identification document depicts the person located at the bag drop station and the photo identification document belongs to the passenger, activating the bag management component to initiate the bag collection process for the bag.
